(19) United States
(12) Patent Application Publication
(10) Pub. No.: US 2024/0055192 A1
(43) Pub. Date: Feb. 15, 2024

(54) ELECTROLYTIC CAPACITOR AND POWER SUPPLY APPARATUS

(71) Applicant: Panasonic Intellectual Property Management Co., Ltd., Osaka (JP)

(72) Inventors: Atsushi YAMASHIMA, Kanagawa (JP); Kentaro HAMASAKI, Kanagawa (JP); Kei TAKAHASHI, Kanagawa (JP); Yusuke SATO, Kanagawa (JP)

(21) Appl. No.: 18/363,409

(22) Filed: Aug. 1, 2023

(30) Foreign Application Priority Data
Aug. 12, 2022 (JP) 2022-128856

(51) Int. Cl. H01G 9/26; H01G 9/10

(52) U.S. Cl. CPC H01G 9/26; H01G 9/10

(57) ABSTRACT

Provided is an electrolytic capacitor including: a plurality of capacitor elements; a plurality of storers that stores the plurality of capacitor elements, respectively; and a sealer that seals the plurality of capacitor elements in the plurality of storers. The plurality of storers is integrally formed.

### TECHNICAL FIELD

The present disclosure relates to an electrolytic capacitor and a power supply apparatus.

### BACKGROUND ART

A power supply apparatus (for example, a charging apparatus for charging a battery, or the like) is typically provided with an electrolytic capacitor. The electrolytic capacitor has a problem of improvement in its heat dissipation since the Arrhenius law or the like reveals that the service life becomes shorter as the temperature becomes higher. In addition, the power supply apparatus requires a large capacity, and further often uses a plurality of electrolytic capacitors to address ripple current, which results in a factor of an increased apparatus size.

For example, Patent Literature (hereinafter referred to “PTL”) 1 discloses an apparatus in which a plurality of electrolytic capacitors is stored in a case and is fixed.

### CITATION LIST

### Patent Literature

PTL 1
Japanese Patent Application Laid-Open No. 2009-164266

### SUMMARY OF INVENTION

### Technical Problem

### Solution to Problem

An electrolytic capacitor according to the present disclosure includes: a plurality of capacitor elements; a plurality of storers that stores the plurality of capacitor elements, respectively; and a sealer that seals the plurality of capacitor elements in the plurality of storers. The plurality of storers is integrally formed.

A power supply apparatus according to the present disclosure includes an electrolytic capacitor. The electrolytic capacitor includes: a plurality of capacitor elements; a plurality of storers that stores the plurality of capacitor elements, respectively; and a sealer that seals the plurality of capacitor elements in the plurality of storers. The plurality of storers is integrally formed.

### Advantageous Effects of Invention

According to the present disclosure, it is possible to realize a reduction in an apparatus size.

### BRIEF DESCRIPTION OF DRAWINGS

FIG. 1 illustrates a power supply apparatus according to an embodiment of the present disclosure;

FIG. 2 is a perspective view of an electrolytic capacitor according to the present embodiment;

FIG. 3 is an exploded perspective view of the electrolytic capacitor according to the present embodiment;

FIG. 4 is an exploded perspective view of a housing portion of the electrolytic capacitor;

FIG. 5 illustrates a main body viewed in the Z direction;

FIG. 6 is an exploded perspective view of a housing portion of an electrolytic capacitor according to a variation;

FIG. 7 is an exploded perspective view of a housing portion of an electrolytic capacitor according to a variation;

FIG. 8 illustrates a main body according to a variation viewed in the Z direction; and

FIG. 9 is a perspective view of an electrolytic capacitor according to a variation.

### DESCRIPTION OF EMBODIMENTS

### Embodiment

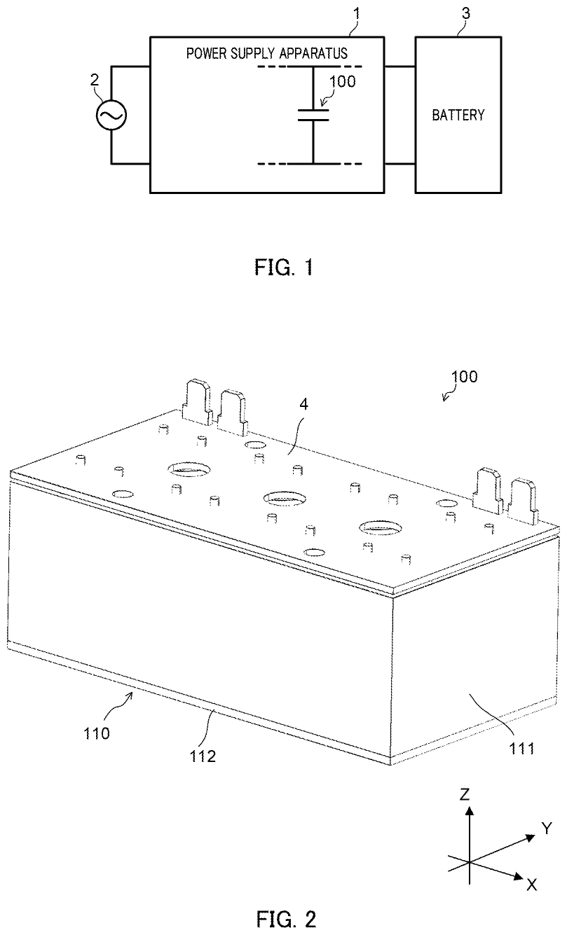

Hereinafter, an embodiment of the present disclosure will be described with reference to the accompanying drawings. FIG. 1 illustrates a power supply apparatus according to an embodiment of the present disclosure. FIG. 2 is a perspective view of an electrolytic capacitor according to the present embodiment.

Note that, in the following description, an orthogonal coordinate system (X, Y, Z) will be used. The drawings to be described later are also illustrated with a common orthogonal coordinate system (X, Y, Z). For example, the X-axis indicates the left-right direction, the Y-axis indicates the front-rear direction, and the Z-axis indicates the up-down direction.

As illustrated in FIG. 1, power supply apparatus 1 is mounted in, for example, a vehicle, and includes a rectifier, a power converter, and the like. Power supply apparatus 1 is connected to external AC power supply 2 outside the vehicle and converts AC power supplied from external AC power supply 2 into DC power to charge battery 3. As illustrated in FIG. 1, power supply apparatus 1 is provided with electrolytic capacitor 100, for example, between the rectifier and the power converter, or the like.

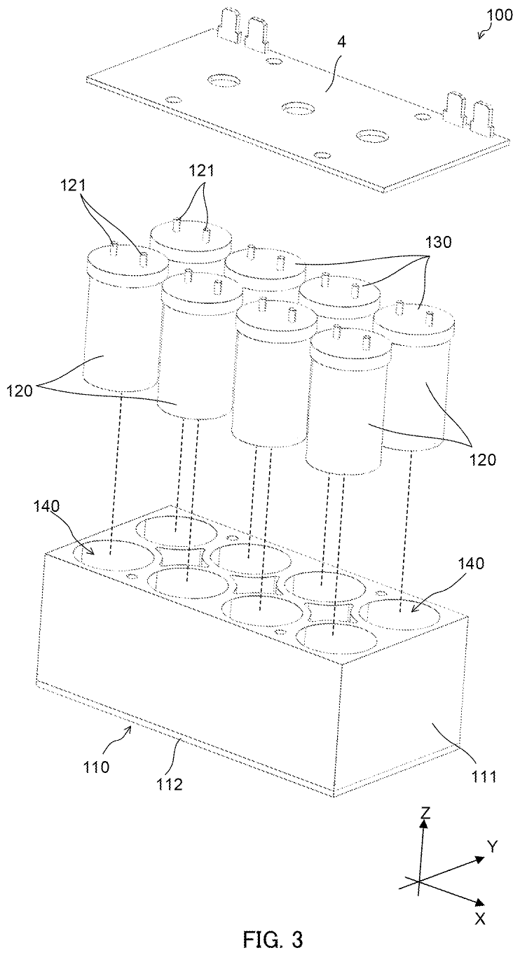

As illustrated in FIG. 2, electrolytic capacitor 100, for example, smooths power supply noise generated accompanied by the conversion of AC power into DC power, and includes housing 110, a plurality of capacitor elements 120, a plurality of sealers 130, and a plurality of storers 140 (see FIG. 3 as well). Electrolytic capacitor 100 is connected to, for example, circuit board 4 that is disposed on the + side of housing 110 in the Z direction.

Housing 110 is formed in, for example, a cuboid shape, and includes main body 111 and bottom wall 112.

As illustrated in FIG. 3, main body 111 is a portion corresponding to a side surface of housing 110, and is formed of, for example, aluminum. In main body 111, the plurality of capacitor elements 120 and the plurality of sealers 130 are stored in the plurality of storers 140, respectively.

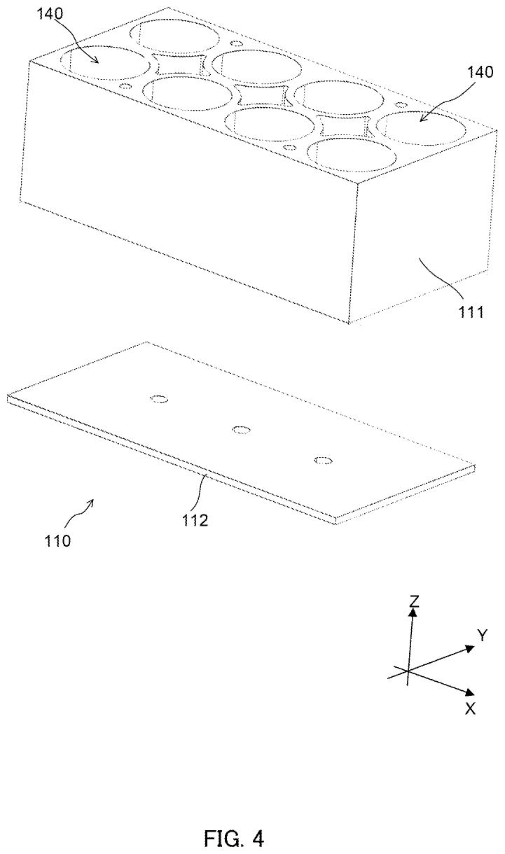

Bottom wall 112 is a portion corresponding to a bottom surface of main body 111, and is formed of, for example, aluminum. As illustrated in FIG. 4, bottom wall 112 is a plate-like member separate from main body 111, and is bonded to main body 111 by a heat dissipation adhesive, welding, screwing, friction stir welding or the like, for example.

As illustrated in FIG. 3, the plurality of capacitor elements 120 is formed in, for example, a columnar shape around which an anode body, a separator, and a cathode body are wound. The plurality of capacitor elements 120 is stored in the plurality of storers 140, respectively. Two lead wires 121 that are connected to the anode body and the cathode body, respectively, are provided in each capacitor element 120 on the + side of in the Z direction.

Two lead wires 121 extend to the + side in the Z direction and are exposed from housing 110 when capacitor element 120 is disposed in housing 110.

Each of the plurality of sealers 130 seals capacitor element 120 disposed in storer 140. Sealer 130 is, for example, an elastic body such as rubber, and is formed in a circular shape that allows storer 140 to be closed.

In sealer 130, through-holes (not illustrated) are formed at positions corresponding to two lead wires 121, and two lead wires 121 are passed through the through-holes and are connected to circuit board 4.

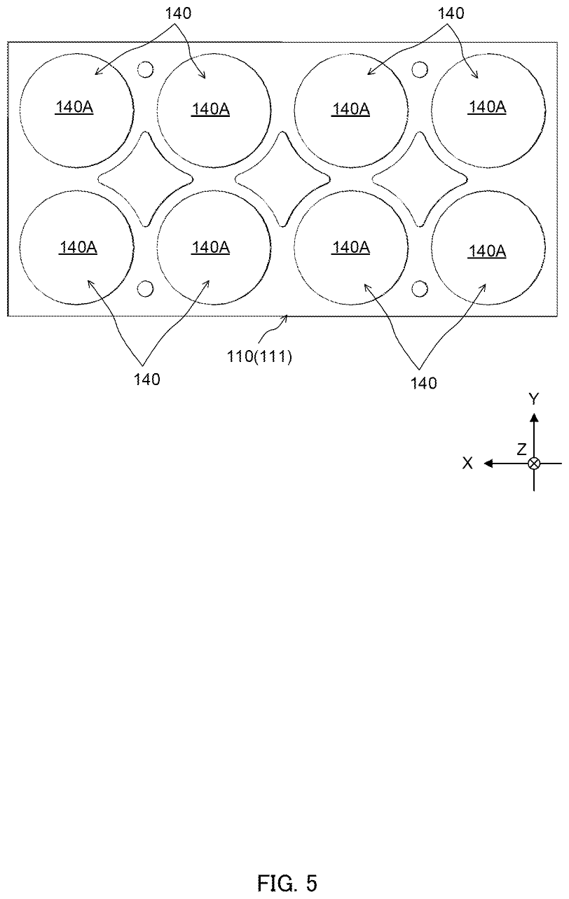

As illustrated in FIG. 5, the plurality of storers 140 is portions that store capacitor elements 120, and each of the plurality of storers 140 is formed integrally with main body 111 of housing 110. The number of storers 140 is determined based on the number of capacitor elements 120 satisfying a capacity required for power supply apparatus 1, the size of housing 110, and the like. The present embodiment indicates an example in which a total of eight storers 140 with four storers 140 in the X direction and two storers 140 in the Y direction are arranged.

Further, the present embodiment indicates an example in which walls of two storers 140 arranged in the X direction, where the walls are adjacent to each other in the X direction, are integrated and walls of two storers 140 arranged in the Y direction, where the walls are adjacent to each other in the Y direction, are integrated. Further, the present embodiment indicates an example in which a total of four storers 140 are arranged in a shape of a square with two storers 140 in the X direction and two storers 140 in the Y direction and a center portion of the square is a space.

Storer 140 includes storage space 140A having the same circular shape as a bottom surface of capacitor element 120 so as to allow capacitor element 120 having a columnar shape to be stored from the + side in the Z direction.

Storage space 140A penetrates main body 111 in the Z direction. Storage space 140A on the − side in the Z direction is closed by main body 111 being joined to bottom wall 112, and capacitor element 120 is stored in storer 140 from the + side in the Z direction. Then, sealer 130 described above is disposed in storage space 140A on the + side in the Z direction, and thus, capacitor element 120 is sealed in storer 140.

Further, insulation processing is applied inside storer 140. Specifically, insulation processing is applied to a wall surface portion, which forms storage space 140A, and the surface of bottom wall 112 on the + side in the Z direction. The insulation processing may be, for example, anodizing, processing of disposing an insulation sheet, processing of applying resin coating, or the like.

Since each capacitor element 120 stored in each storer 140 is insulated thereby, it is possible to decrease the distance between adjacent capacitor elements 120.

Further, main body 111 and storer 140 are formed by, for example, extrusion. Thus, store space 140A formed of an inner wall surface parallel to the Z direction can be formed.

Functions and effects of electrolytic capacitor 100 according to the present embodiment as configured in the above-described manner will be described.

In a configuration in the related art in which a plurality of electrolytic capacitors is stored, a plurality of typical electrolytic capacitors in which a capacitor element is stored in an exterior body having a double structure with an aluminum case and a sleeve is stored in a case, for example. That is, the configuration in the related art does not allow a size reduction above a certain level.

In the present embodiment, on the other hand, the plurality of storers 140 in electrolytic capacitor 100 is integrally formed. That is, the present embodiment has a configuration with at least no exterior body having a double structure and therefore makes it possible to bring capacitor elements 120 closer to each other than the typical electrolytic capacitors described above. As a result, it is possible to realize a reduction in an apparatus size more than the configuration in the related art.

Further, in the configuration in the related art, each electrolytic capacitor is fixed in a case via another material such as a potting material and a foaming material, and thus, thermal conduction between the case, which comes into contact with a heat dissipation member, a cooling member or the like, and the electrolytic capacitor is performed via the other material. Accordingly, in the configuration in the related art, there is a certain limit to heat dissipation as well.

In the present embodiment, on the other hand, the plurality of storers 140 in electrolytic capacitor 100 is integrally formed. Accordingly, thermal conduction is smoothly performed, not via another material as in the configuration in the related art. That is, the present embodiment makes it possible to improve heat dissipation more than the configuration in the related art.

Further, in the present embodiment, insulation processing is applied to the inside of storer 140. Accordingly, it can be configured that capacitor elements 120, that is, the contents of the electrolytic capacitor in the configuration in the related art are simply arranged. Then, storing these capacitor elements 120 in the plurality of storers 140 that are integrated makes it possible to reduce the entire size.

Further, since the plurality of storers 140 forms housing 110 that includes the side surface and the bottom surface, it is possible to cause housing 110 to dissipate heat easily, for example, by disposing housing 110 at a location at which a cooling member is disposed, by disposing a heat dissipation member such as a heat sink at a location at which housing 110 is disposed, or the like. As a result, it is possible to further improve the heat dissipation of electrolytic capacitor 100.

Further, since the plurality of storers 140 and the side surface are formed by extrusion, it is possible to cause the inner wall surface, which forms storage space 140A of storer 140, to have a shape parallel to the Z direction. For example, in the case of a molded product, there is a draw taper, and thus, there is a portion in which a storage space of a storer extends.

In the present embodiment, on the other hand, the inner wall surface, which forms storage space 140A of storer 140, has a shape parallel to the Z direction. Accordingly, there is no portion in which a storage space extends as in the configuration configured with a molded product. As a result, a reduction in an apparatus size can be performed. Further, it is possible to simply create storer 140 by extrusion.

Further, since the bottom surface is formed of a metal separate from the plurality of storers 140 and the side surface, a highly conductive portion can be easily brought into contact with a cooling member or a heat dissipation member by disposing housing 110 at a position at which the cooling member or the heat dissipation member is disposed. As a result, it is possible to cause heat dissipation to easily improve.

Further, since the plurality of storers 140 and the side surface are formed of aluminum, an inexpensive configuration can be realized while a material having an excellent thermal conductivity is used.

Note that, in the embodiment described above, the bottom surface is formed of a metal separate from storer 140 and the side surface, but the present disclosure is not limited thereto. The bottom surface may be formed integrally with the side surface. Further, the bottom surface may be configured to include an elastic body.

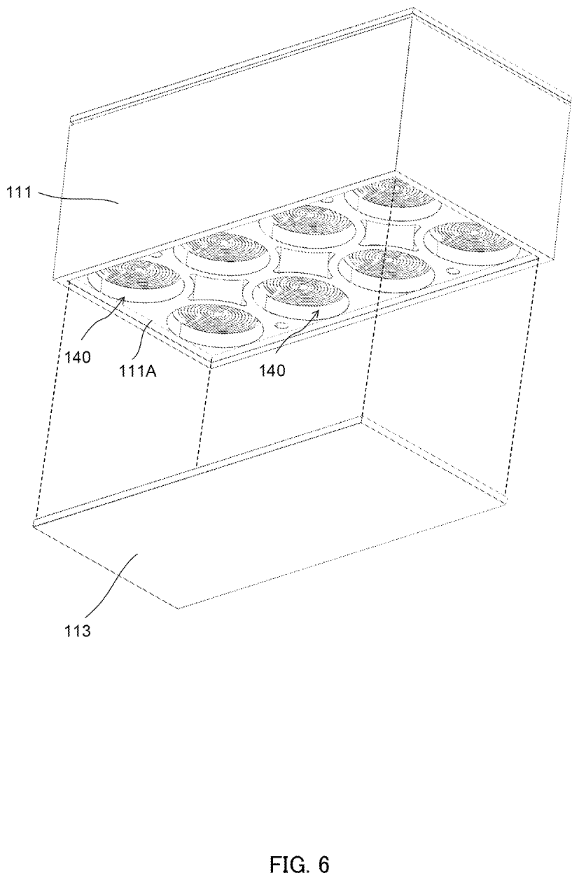

For example, as illustrated in FIG. 6, the bottom surface may also be formed of elastic plate 113 separate from storer 140 and the side surface.

Elastic plate 113 is, for example, rubber and is formed in a plate shape. Elastic plate 113 is bonded to main body 111 on the − side in the Z direction by a publicly known method. Main body 111 on the − side in the Z direction is provided with recess 111A in which elastic plate 113 can be disposed, and elastic plate 113 is disposed in recess 111A.

Thus, an inexpensive configuration can be realized while capacitor element 120 in storer 140 is sealed from the − side in the Z direction.

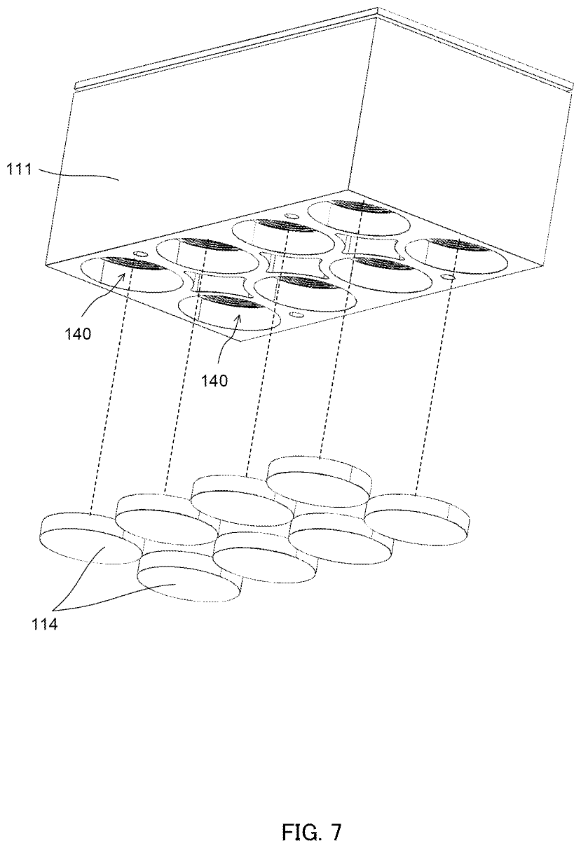

Further, as illustrated in FIG. 7, the bottom surface may include elastic body 114 capable of sealing each opening portion of the plurality of storers 140 on the − side in the Z direction.

Elastic body 114 is formed in a circular shape that allows the opening portion of storer 140 to be sealed. A plurality of elastic bodies 114 is provided corresponding to the number of storers 140. In the example indicated in FIG. 7, eight elastic bodies 114 are provided.

Thus, an inexpensive configuration can be realized while each of capacitor elements 120 in storers 140 is sealed from the − side in the Z direction.

Note that, although the elastic members such as elastic plate 113 and elastic body 114 are exemplified in FIGS. 6 and 7, for example, an insulation sheet (for example, a polycarbonate sheet or the like) and other members may also be used.

Further, a typical electrolytic capacitor is provided with an explosion-proof valve at a leading end portion or the like. For example, in a case where the pressure in the electrolytic capacitor increases, the explosion-proof valve breaks, thereby extracting the pressure inside the electrolytic capacitor to prevent the electrolytic capacitor from exploding. Although no explosion-proof valve of electrolytic capacitor 100 is particularly mentioned in the embodiment described above, an explosion-proof valve may be provided.

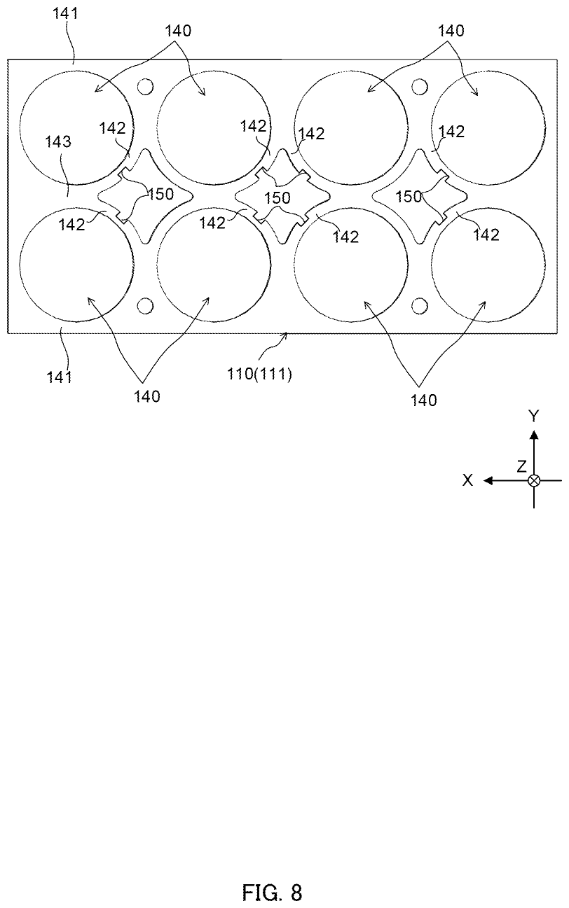

For example, as illustrated in FIG. 8, storer 140 may include explosion preventer 150 that prevents a rupture of storer 140.

Explosion preventer 150 is provided in a wall of storer 140, where the wall is located on an inner side of storer 140 in housing 110. Specifically, storer 140 includes first wall 141, which forms an outer wall of housing 110, and second wall 142, which faces an inner space of housing 110. Second wall 142 corresponds to the “facing wall” in the present disclosure.

The inner space of housing 110 is a space other than storers 140, and explosion preventer 150 is provided in second wall 142.

Explosion preventer 150 is formed in, for example, a groove shape extending in the Z direction. Since the portion of explosion preventer 150 is thinner than the other portions, the portion of explosion preventer 150 easily breaks when the pressure in storer 140 increases.

The breakage of explosion preventer 150 prevents a rupture of storer 140. Further, the breakage of explosion preventer 150 toward the inner space of housing 110 makes it possible to suppress an influence on the periphery of electrolytic capacitor 100.

Further, in the embodiment described above, the bottom surface of housing 110 is brought into contact with a cooling member or a heat dissipation member to thereby dissipate heat of electrolytic capacitor 100, but the present disclosure is not limited thereto. For example, the side surface of housing 110 may be brought into contact with a heat dissipation member to dissipate heat.

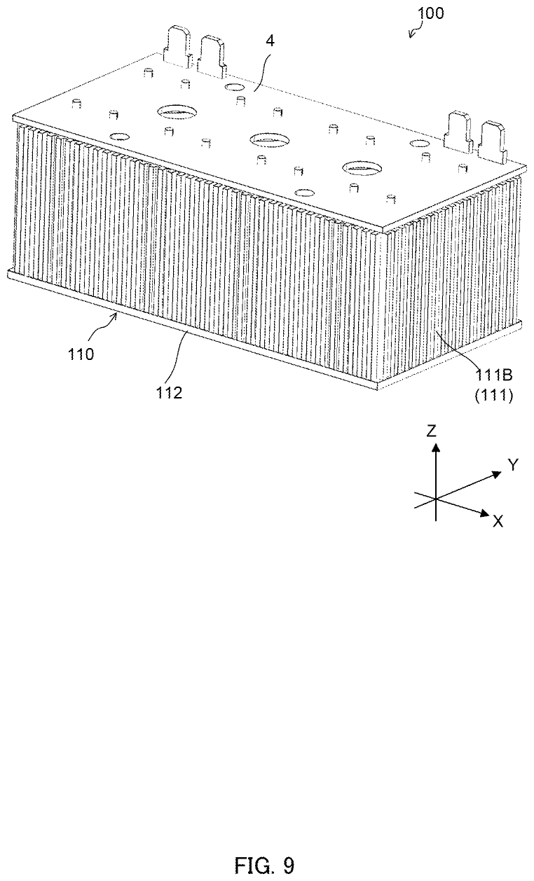

Further, as illustrated in FIG. 9, electrolytic capacitor 100 may also include heat dissipater 111B that is provided in main body 111 of housing 110. Heat dissipater 111B may be, for example, a fin projecting from the side surface.

Thus, for example, even in a case where the bottom surface of housing 110 cannot come into contact with a heat dissipation member, it is possible to dissipate heat.

Further, in the embodiment described above, storer 140 and the side surface are formed by extrusion, but the present disclosure is not limited thereto. For example, storer 140 and the side surface may be formed by die casting or the like as molded products. In this case, the bottom surface is formed integrally with the side surface and the storer.

Further, in the embodiment described above, the side surface and the storer are integrally formed, but in a case where the bottom surface is formed integrally with the side surface and the storer, the storer and the side surface may be separated from each other.

Further, although the embodiment described above has a shape in which the storers are arranged in two rows, the present disclosure is not limited thereto. The shape may be a shape in which the storers are arranged in a row. Alternatively, the stores may be arranged in any way as long as the storers can be arranged in the power supply apparatus, such as a shape in which the storers are arranged in an L shape.

Further, although the embodiment described above indicates the example in which a total of four storers 140 are arranged in a shape of a square with two storers 140 in the X direction and two storers 140 in the Y direction and the center portion of the square is a space, the present disclosure is not limited thereto, and no space other than storers 140 may be formed in housing 110.

Further, in the embodiment described above, the electrolytic capacitor is formed in the shape of the housing (cuboid shape), but the present disclosure is not limited thereto, and the electrolytic capacitor may not have the shape of the housing. For example, the electrolytic capacitor may have a shape in which a plurality of storers having a cylindrical shape are connected as they are.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2022-128856, filed on Aug. 12, 2022, the disclosure of which including the specification, drawings and abstract is incorporated herein by reference in its entirety.

### INDUSTRIAL APPLICABILITY

The electrolytic capacitor of the present disclosure is useful as an electrolytic capacitor and a power supply apparatus each capable of realizing a reduction in an apparatus size.

1. An electrolytic capacitor, comprising:
a plurality of capacitor elements;
a plurality of storers that stores the plurality of capacitor elements, respectively; and
a sealer that seals the plurality of capacitor elements in the plurality of storers, wherein
the plurality of storers is integrally formed.

2. The electrolytic capacitor according to claim 1, wherein insulation processing is applied to an inside of each of the plurality of storers.

3. The electrolytic capacitor according to claim 1, wherein the plurality of storers partially forms a housing that includes a side surface and a bottom surface.

4. The electrolytic capacitor according to claim 3, wherein the plurality of storers and the side surface are formed by extrusion.

5. The electrolytic capacitor according to claim 4, wherein the bottom surface is formed separately from the plurality of storers and the side surface.

6. The electrolytic capacitor according to claim 4, wherein the bottom surface is configured to include a member that seals the plurality of storers.

7. The electrolytic capacitor according to claim 3, wherein:
at least one of the plurality of storers includes a facing wall that faces an inner space of the housing, and
the facing wall includes an explosion preventer that prevents a rupture of the corresponding one of the plurality of storers.

8. The electrolytic capacitor according to claim 3, further comprising a heat dissipater that is provided in the side surface.

9. The electrolytic capacitor according to claim 3, wherein the plurality of storers and the side surface are formed of aluminum.

10. A power supply apparatus comprising an electrolytic capacitor, wherein:
the electrolytic capacitor includes:
a plurality of capacitor elements;
a plurality of storers that stores the plurality of capacitor elements, respectively; and
a sealer that seals the plurality of capacitor elements in the plurality of storers, and
the plurality of storers is integrally formed.

11. The power supply apparatus according to claim 10, wherein insulation processing is applied to an inside of each of the plurality of storers.

12. The power supply apparatus according to claim 10, wherein the plurality of storers partially forms a housing that includes a side surface and a bottom surface.

13. The power supply apparatus according to claim 12, wherein the plurality of storers and the side surface are formed by extrusion.

14. The power supply apparatus according to claim 13, wherein the bottom surface is formed separately from the plurality of storers and the side surface.

15. The power supply apparatus according to claim 13, wherein the bottom surface is configured to include a member that seals the plurality of storers.

16. The power supply apparatus according to claim 12, wherein:
at least one of the plurality of storers includes a facing wall that faces an inner space of the housing, and
the facing wall includes an explosion preventer that prevents a rupture of the corresponding one of the plurality of storers.

17. The power supply apparatus according to claim 12, further comprising a heat dissipater that is provided in the side surface.

18. The power supply apparatus according to claim 12, wherein the plurality of storers and the side surface are formed of aluminum.
